(19) United States
(12) Patent Application Publication
(10) Pub. No.: US 2010/0326273 A1
(43) Pub. Date: Dec. 30, 2010

(54) PLASTICIZATION RESISTANT MEMBRANES

(75) Inventors: Chunqing Liu, Schaumburg, IL (US); Stephen T. Wilson, Libertyville, IL (US); Jeffrey J. Chiou, Irvine, CA (US); David A. Lesch, Hoffman Estates, IL (US); Santi Kulprathipanja, Inverness, IL (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(73) Assignee: UOP LLC, Des Plaines, IL (US)

(21) Appl. No.: 12/875,878

(22) Filed: Sep. 3, 2010

Related U.S. Application Data
(63) Continuation-in-part of application No. 11/537,372, filed on Sep. 29, 2006.

(51) Int. Cl. B01D 53/22

(52) U.S. Cl. 95/45; 96/14; 96/10

(57) ABSTRACT

This invention discloses a composition of, a method of making, and an application of high plasticization-resistant chemically cross-linked organic-inorganic hybrid membranes such as cross-linked cellulose acetate-cellulose triacetate-polyurethanepropylsilsesquioxane membranes. These cross-linked membranes with covalently interpolymer-chain-connected hybrid networks were prepared via a sol-gel condensation polymerization of cross-linkable organic polymer-organosilicon alkoxide precursor membrane materials. CO₂ plasticization tests on these cross-linked membranes demonstrate extremely high CO₂ plasticization resistance under CO₂ pressure up to 5516 kPa (800 psig). These new cross-linked membranes can be used not only for gas separations such as CO₂/CH₄ and CO₂/N₂ separations, O₂/N₂ separation, olefin/paraffin separations (e.g. propylene/propane separation), iso/normal paraffins separations, but also for liquid separations such as desalination.

### CROSS-REFERENCE TO RELATED APPLICATION

This application is a Continuation-In-Part of copending application Ser. No. 11/537,372 filed Sep. 29, 2006, the contents of which are hereby incorporated by reference in its entirety.

### FIELD OF THE INVENTION

This invention pertains to plasticization-resistant chemically cross-linked organic-inorganic hybrid membranes and methods of making the same. This invention also pertains to the use of these cross-linked membranes for a variety of liquid and gas separations.

### BACKGROUND OF THE INVENTION

Membrane-based technologies have advantages of both low capital cost and high-energy efficiency compared to conventional separation methods. Polymeric membranes have proven to operate successfully in industrial gas separations such as in the separation of nitrogen from air and the separation of carbon dioxide from natural gas. Cellulose acetate (CA) is a polymer currently being used in commercial gas separation. For example, UOP LLC's Separex™ CA membrane is used extensively for carbon dioxide removal from natural gas. Nevertheless, while they have experienced commercial success, CA membranes still need improvement in a number of properties including selectivity, permeability, chemical and thermal stability. Natural gas often contains substantial amounts of heavy hydrocarbons and water, either as an entrained liquid, or in vapor form, which may lead to condensation within membrane modules. The gas separation capabilities of CA membranes are affected by contact with liquids including hydrocarbons and water. The presence of more than modest levels of hydrogen sulfide, especially in conjunction with water and heavy hydrocarbons, is also potentially damaging. Therefore, precautions must be taken to remove the entrained liquid water and heavy hydrocarbons upstream of the membrane separation steps. Another issue of CA polymer membranes that still needs to be addressed for their use in gas separations is the plasticization of the polymer by condensable gases such as carbon dioxide and propylene that leads to swelling of the membrane as well as a significant increase in the permeability of all components in the feed and a decrease in the selectivity of CA membranes. For example, the permeation behavior of CO₂ in CA membranes is different when compared to some other glassy polymers in that above a certain pressure level, the permeability coefficient begins to increase with pressure due to the onset of plasticization by the CO₂. A high concentration of sorbed CO₂ leads to increased segmental motion, and, consequently, the transport rate of the penetrant is enhanced. The challenge of treating gas, such as natural gas, that contains relatively large amounts of CO₂, such as more than about 10%, is particularly difficult.

Polymeric membrane materials have been found to be of use in gas separations. Numerous research articles and patents describe polymeric membrane materials (e.g., polyimides, polysulfones, polycarbonates, polyethers, polyamides, polyarylates, polypyrrolones, etc.) with desirable gas separation properties, particularly for use in oxygen/nitrogen separation (See, for example, U.S. Pat. No. 6,932,589). The polymeric membrane materials are typically used in processes in which a feed gas mixture contacts the upstream side of the membrane, resulting in a permeate mixture on the downstream side of the membrane with a greater mole fraction of one of the components than the composition of the original feed gas mixture. A pressure differential is maintained between the upstream and downstream sides, providing the driving force for permeation. The downstream side can be maintained as a vacuum, or at any pressure below the upstream pressure.

The membrane performance is characterized by the flux of a gas component across the membrane. This flux can be expressed as a quantity called the permeability (P), which is a pressure- and thickness-normalized flux of a given component. The separation of a gas mixture is achieved by a membrane material that permits a faster permeation rate for one component (i.e., higher permeability) over that of another component. The efficiency of the membrane in enriching a component over another component in the permeate stream can be expressed as a quantity called selectivity. Selectivity can be defined as the ratio of the permeabilities of the gas components across the membrane (i.e., P_{A}/P_{B}, where A and B are the two components). A membrane's permeability and selectivity are material properties of the membrane material itself, and thus these properties are ideally constant with feed pressure, flow rate and other process conditions. However, permeability and selectivity are both temperature-dependent. It is desired to develop membrane materials with a high selectivity (efficiency) for the desired component, while maintaining a high permeability (productivity) for the desired component.

The relative ability of a membrane to achieve the desired separation is referred to as the separation factor or selectivity for the given mixture. There are however several other obstacles to use of a particular polymer to achieve a particular separation under any sort of large scale or commercial conditions. One such obstacle is permeation rate. One of the components to be separated must have a sufficiently high permeation rate at the preferred conditions or else extraordinarily large membrane surface areas are required to allow separation of large amounts of material. Another problem that can occur is that at conditions where the permeability is sufficient, such as at elevated temperatures or pressures, the selectivity for the desired separation can be lost or reduced. Another problem that often occurs is that over time the permeation rate and/or selectivity is reduced to unacceptable levels. This can occur for several reasons. One reason is that impurities present in the mixture can over time clog the pores, if present, or interstitial spaces in the polymer. Another problem that can occur is that one or more components of the mixture can alter the form or structure of the polymer membrane over time thus changing its permeability and/or selectivity. One specific way this can happen is if one or more components of the mixture cause plasticization of the polymer membrane. Plasticization occurs when one or more of the components of the mixture act as a solvent in the polymer often causing it to swell and lose its membrane properties. It has been found that polymers such as cellulose acetate and polyimides which have particularly good separation factors for separation of mixtures comprising carbon dioxide and methane are prone to plasticization over time thus resulting in decreasing performance of these membranes.

The present invention overcomes some of the problems of the prior art membranes by providing a cross-linked hybrid inorganic-organic polymer membrane and a route to making said polymer membrane that has the following properties/advantages:

Excellent selectivity and permeability with sustained selectivity over time by resistance to plasticization.

Some new high-performance polymers such as polyimides (PIs), poly(trimethylsilylpropyne) (PTMSP), and polytriazole exhibit a high ideal selectivity for CO₂ over CH₄ when measured with pure gases at modest pressures in the laboratory. However, the selectivity obtained under mixed gas, high pressure conditions is much lower than the calculated ideal level. In addition, gas separation processes based on glassy solution-diffusion membranes frequently suffer from plasticization of the stiff polymer matrix by the sorbed penetrant molecules such as CO₂ or C₃H₆. Plasticization of the polymer represented by the membrane structure swelling and a significant increase in the permeabilities of all components in the feed occurs above the plasticization pressure when the feed gas mixture contains condensable gases.

Thus, there is a critical need for new high-performance membranes that will provide and maintain adequate performance under conditions of exposure to organic vapors, high concentrations of acid gases such as CO₂ and hydrogen sulfide, and water vapor that are commonplace in natural gas treatment.

Conventional methods for stabilizing polymeric membranes involve either annealing or cross-linking Cross-linking is a useful method to suppress the polymer membrane plasticization. Polymer membrane cross-linking methods include thermal treatment, radiation, chemical cross-linking, and UV-photochemical processes. Cross-linking offers the potential to improve the mechanical and thermal properties of a membrane. Cross-linking can be used to increase membrane stability in the presence of aggressive feed gases and to simultaneously reduce plasticization of the membrane. Normally, cross-linked polymer membranes have a high resistance to plasticization, but their other properties such as permeability and selectivity are less than desired.

Even after cross-linking of conventional polymers in accordance with the state of the art prior to the current invention, there has remained a need to improve the selectivity and permeability of the resulting membranes.

Here in this invention, we disclose for the first time a novel chemical cross-linking method for the preparation of high plasticization-resistant chemically cross-linked organic-inorganic hybrid membranes, and applications using such membranes.

### SUMMARY OF THE INVENTION

This invention discloses a composition of, a method of making, and applications for use of high plasticization-resistant chemically cross-linked organic-inorganic hybrid membranes such as cross-linked cellulose acetate (CA)-cellulose triacetate (CTA)-polyurethanepropylsilsesquioxane organic-inorganic hybrid membranes. These cross-linked organic-inorganic hybrid membranes with covalently interpolymer-chain-connected hybrid networks were prepared via a sol-gel hydrolysis and condensation polymerization of cross-linkable organic polymer-organosilicon alkoxide precursor membrane materials in the presence of a certain amount of a catalyst such as acetic acid. The cross-linkable precursor membrane materials were synthesized by covalently binding organosilicon alkoxide to the terminus or the side chain groups of a polymer membrane material.

The beauty of these high plasticization-resistant chemically cross-linked organic-inorganic hybrid polymer membranes is that they combine characteristics of both organic polymer membranes and inorganic membranes and contribute to solving the disadvantages connected to each of them when they are used separately without the present invention. The main issues for polymer membrane are selectivity, chemical, mechanical, thermal, and pressure stabilities. The inorganic membranes have technical limitations and suffer from problems such as brittleness and lack of surface integrity. Here in this invention, the degree of cross-linking can be controlled easily by adjusting the molar ratio of the precursor organic polymer to the organosilicon alkoxide cross-linking agent. In addition, these cross-linked organic-inorganic hybrid polymer membranes are different from inorganic filler-polymer mixed matrix membranes in that they have no phase separation between the organic polymer and the inorganic cross-linking agent, no inorganic particle size issue, much better chemical and mechanical stability compared to inorganic filler-polymer mixed matrix membranes. Most importantly, these cross-linked organic-inorganic hybrid polymer membranes described in this invention exhibit extremely high plasticization resistance to condensable gases such as CO₂. Single-gas experimental results demonstrated that the chemically cross-linked organic-inorganic hybrid membranes described in this invention showed significant suppression of plasticization induced by CO₂ or other condensable gases.

Another embodiment of the invention comprises a process for separating at least one gas from a mixture of gases. The process comprises providing a chemically cross-linked polymer membrane comprising an organic polymer, an organosilsesquioxane segment, and a covalent bond between the organic polymer and the organosilsesquioxane segment wherein the cross-linked organic-inorganic hybrid membrane is permeable to said at least one gas; contacting the mixture of gases to a first side of the membrane to cause the at least one gas to permeate the cross-linked organic-inorganic hybrid membrane; and removing from a second side of the cross-linked organic-inorganic hybrid membrane a permeate gas composition comprising at least a portion of the at least one gas which permeated the cross-linked organic-inorganic hybrid membrane.

The organic polymer is preferably selected from the group consisting of poly(ethylene glycol)s; poly(ethylene oxide)s; cellulose acetate; cellulose triacetate; poly(ethylene imine)s; polyimide comprising a repeating unit obtained from aromatic diamine including at least one ortho-positioned hydroxyl functional group and mixtures thereof.

The mixture of gases may be a pair of gases selected from the group consisting of carbon dioxide/natural gas, hydrogen/methane, carbon dioxide/nitrogen, methane/nitrogen, iso/normal paraffins and olefins/paraffins.

The organosilsesquioxane segment may include ethylsilsesquioxane, propylsilsesquioxane, hexylsilsesquioxane, and mixtures thereof. The covalent bond is selected from the group consisting of an ether bond, a urethane bond, and mixtures thereof.

A chemically cross-linked polymer membrane of the present invention comprises an organic polymer, an organosilsesquioxane segment, and a covalent bond between the organic polymer and the organosilsesquioxane segment wherein the chemically cross-linked polymer membrane is permeable to at least one gas. The organic polymer may be selected from the group consisting of poly(ethylene glycol)s; poly(ethylene oxide)s; cellulose acetate; cellulose triacetate; polyimide comprising a repeating unit obtained from aromatic diamine including at least one ortho-positioned hydroxyl functional group and mixtures thereof. The organosilsesquioxane segment may be selected from the group consisting of ethylsilsesquioxane, propylsilsesquioxane, hexylsilsesquioxane and mixtures thereof. The covalent bond in the membrane may be selected from the group consisting of an ether bond, a urethane bond and mixtures thereof.

These new cross-linked membranes are highly promising not only for a variety of gas separations such as separations of CO₂/CH₄, CO₂/N₂, olefin/paraffin separations (e.g. propylene/propane separation), H₂/CH₄, O₂/N₂, iso/normal paraffins, polar molecules such as H₂O, H₂S, and NH₃ mixtures with CH₄, N₂, H₂, and other light gases separations, but also for liquid separations such as desalination and pervaporation.

### BRIEF DESCRIPTION OF THE DRAWINGS

FIG. 1 is a flowchart showing the steps in preparing cross-linked organic-inorganic hybrid membranes.

FIG. 2 is a flowchart showing an alternative process for preparing cross-linked organic-inorganic hybrid membranes with addition of an additional cross-linking agent.

FIG. 3 shows Products 1 and 2, the products of the processes of FIGS. 1 and 2, respectively.

FIG. 4 shows the preparation of cross-linkable CA-urethanepropyltriethoxysilane organic-inorganic membrane material.

FIG. 5 shows the preparation of cross-linked CA-Urethane-Si-2-1 membrane.

FIG. 6 shows the FTIR spectra of a cellulose acetate membrane and a cross-linked CA-Urethane-Si-2-1 membrane of the present invention.

FIG. 7 shows preparation of cross-linkable CA-etheralkyltrimethoxysilane organic-inorganic hybrid precursor membrane material.

FIG. 8 shows the preparation of cross-linkable CTA-urethanepropyltriethoxysilane organic-inorganic membrane material.

FIG. 9 shows the preparation of cross-linked CTA-Urethane-Si-1-1 membrane.

FIG. 10 shows the preparation of cross-linked HPIS membranes.

FIG. 11 shows effect of CO₂ pressure up to 1724 kPa (250 psig) on CO₂ permeability (P_{CO2}) in CA and cross-linked CA-Urethane-Si-2-1 membranes at 50° C.

FIG. 12 shows the effect of CO₂ pressure up to 5861 kPa (850 psig) on CO₂ permeability (P_{CO2}) in cross-linked CA-Urethane-Si-2-1 membranes at 50° C.

FIG. 13 shows the effect of the applied CO₂ pressures on the relative CO₂ permeability in the (a) original CA-CTA, and cross-linked CA-Urethane-Si-2-1, and (c) cross-linked CA-Urethane-Si-1-1 membranes at 50° C.

FIG. 14 shows the effect of the applied CO₂ pressures on the relative CO₂ permeability in the (a) original CA-CTA, and (b) cross-linked CA-CTA-Urethane-Si-2-1 at 50° C.

### DETAILED DESCRIPTION OF THE INVENTION

Current polymeric membrane materials have reached a limit in their productivity-selectivity trade-off relationship for separations. Another issue is that gas separation processes based on glassy solution-diffusion membranes frequently suffer from plasticization of the stiff polymer matrix by the sorbed condensable penetrant molecules such as CO₂ or C₃H₆. Plasticization of the polymer is exhibited by swelling of the membrane structure and a significant increase in the permeabilities for all components in the feed occurs above the plasticization pressure when the feed gas mixture contains condensable gases.

For example, for a cellulose acetate membrane, the high solubility of CO₂ swells the polymer to such an extent that intermolecular interactions are disrupted. As a result, mobility of the acetyl and hydroxyl pendant groups, as well as small-scale main chain motions, would increase thereby enhancing the gas transport rates. This result indicates a strong need to develop new plasticization-resistant membrane materials. The markets for membrane processes could be expanded considerably through the development of robust, high plasticization-resistant membrane materials. However, so far no effective method has been found to reduce the plasticization of CA membrane.

Conventional methods for stabilizing the polymeric membranes against plasticization are either annealing or cross-linking Polymeric membrane cross-linking methods include thermal treatment, radiation, chemical cross-linking, UV-photochemical, blending with other polymers, etc.

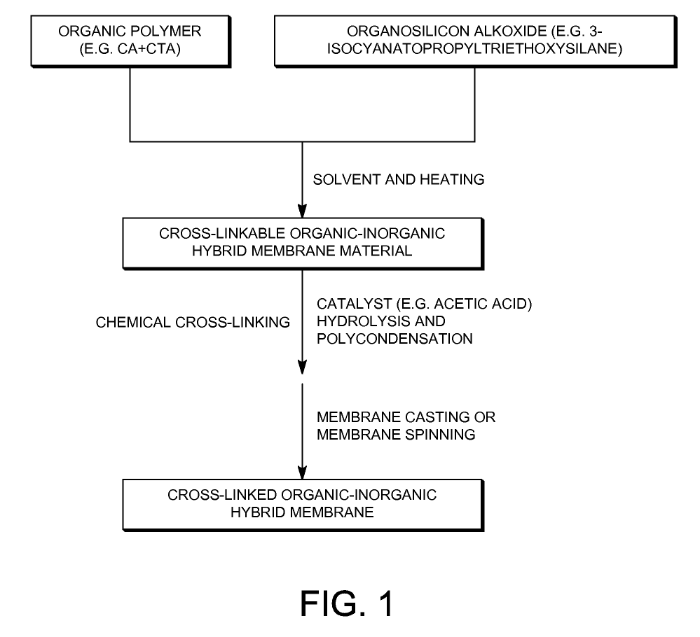

This invention relates to novel high plasticization-resistant chemically cross-linked organic-inorganic hybrid membranes (or cross-linked organic-inorganic hybrid dense films) such as cross-linked cellulose acetate (CA)-cellulose triacetate (CTA)-polyurethanepropylsilsesquioxane organic-inorganic hybrid membranes. More specifically, this invention relates to a method for making these novel high plasticization-resistant chemically cross-linked organic-inorganic hybrid membranes such as a cross-linked cellulose acetate (CA)-cellulose triacetate (CTA)-polyurethanepropylsilsesquioxane organic-inorganic hybrid membrane as shown in FIG. 1. This invention also pertains to the application of these cross-linked membranes not only for a variety of gas separations such as separations of CO₂/CH₄, CO₂/N₂, olefin/paraffin separations (e.g. propylene/propane separation), H₂/CH₄, O₂/N₂, iso/normal paraffins, polar molecules such as H₂O, H₂S, and NH₃/mixtures with CH₄, N₂, H₂, and other light gases. separations, but also for liquid separations such as desalination and pervaporation.

The cross-linked organic-inorganic hybrid membranes described in this invention can be prepared via a sol-gel condensation polymerization of cross-linkable organic polymer-organosilicon alkoxide precursor membrane materials. The cross-linkable precursor membrane materials can be synthesized by covalently bonding organosilicon alkoxide to the terminus or the side chain groups of a polymer membrane material or a mixture of two or more polymer membrane materials. Subsequent hydrolysis and condensation of these cross-linkable precursor membrane materials in the presence of the catalyst followed by membrane casting or spinning yield cross-linked organic-inorganic hybrid membranes. These cross-linked organic-inorganic hybrid membranes contain covalent interpolymer-chain-connected hybrid networks, which can effectively reduce or stop the swelling of the polymer to such an extent that intermolecular interactions cannot be disrupted. As a result, the mobility of the polymer main chain can significantly decrease, thereby enhancing the stability of polymer membrane against plasticization. The design of successful cross-linked organic-inorganic hybrid membranes as described herein is based on the proper selection of the precursor organic polymer, organosilicon alkoxide cross-linking agent, and the cross-linking catalyst. The cross-linked organic-inorganic hybrid membranes can be used in any convenient form such as sheets, tubes or hollow fibers.

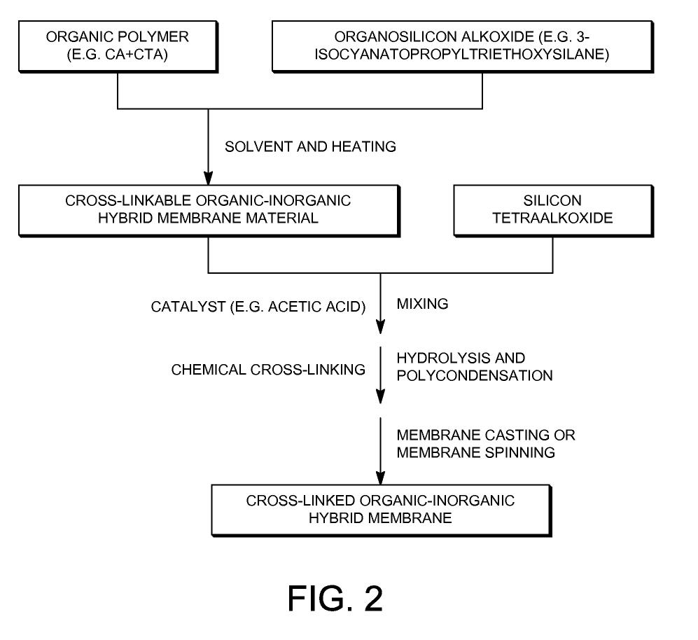

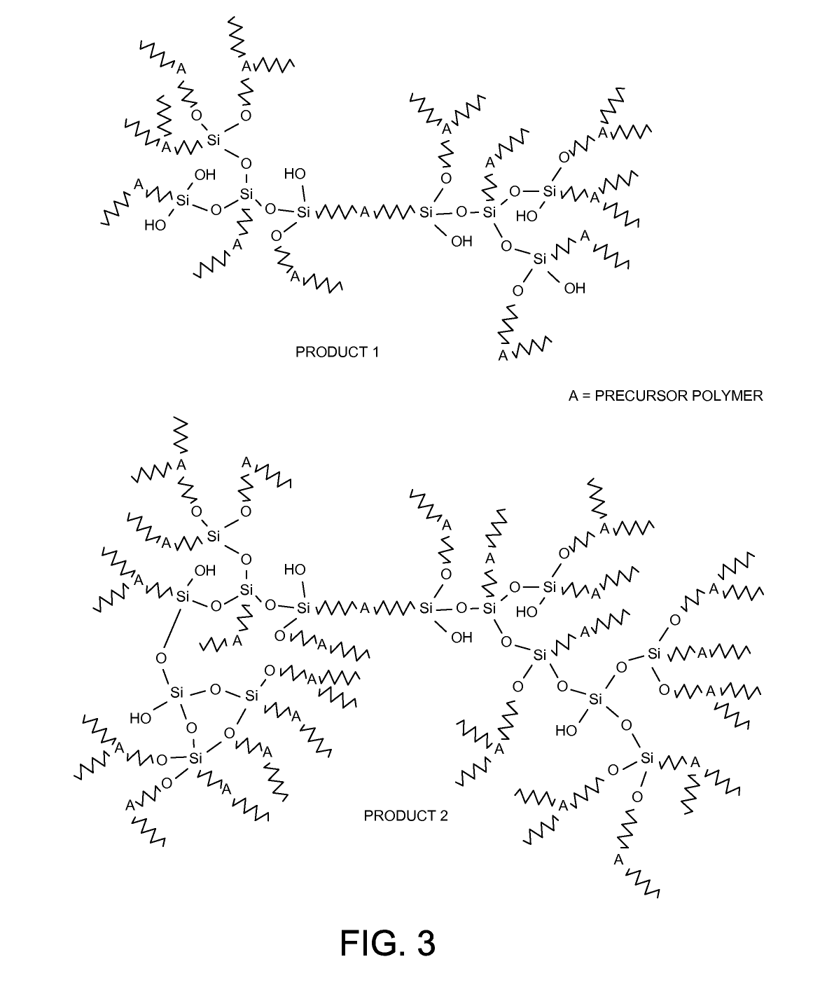

The cross-linked organic-inorganic hybrid membranes described in this invention can also be prepared via a sol-gel condensation polymerization of cross-linkable organic polymer-organosilicon alkoxide and silicon tetraalkoxide precursor membrane materials (FIG. 2). The cross-linkable precursor membrane materials can be synthesized by covalently bonding an organosilicon alkoxide to the terminus or the side chain groups of a polymer membrane material or a mixture of two or more polymer membrane materials and then adding a certain amount of silicon tetraalkoxide. Subsequent hydrolysis and condensation of these cross-linkable precursor membrane materials in the presence of the catalyst followed by membrane casting or spinning yield cross-linked organic-inorganic hybrid membranes. These cross-linked organic-inorganic hybrid membranes contain covalently bonded interpolymer-chain-connected hybrid networks, which can effectively reduce or stop the swelling of the polymer to such an extent that intermolecular interactions are not disrupted. As a result, the mobility of the polymer main chain can significantly decrease and thereby enhancing the stability of polymer membrane against plasticization. The design of a successful cross-linked organic-inorganic hybrid membranes described herein is based on the proper selection of the precursor organic polymer, organosilicon alkoxide and silicon tetraalkoxide cross-linking agents, and the cross-linking catalyst. A comparison of the products of the processes outlined in FIGS. 1 and 2 can be found in FIG. 3, with the addition of the second cross-linking agent shown in Product 2 as compared to Product 1.

The cross-linked organic-inorganic hybrid membranes can be used in any convenient form such as sheets, tubes or hollow fibers.

The precursor organic polymer provides a wide range of properties important for membrane separations including low cost, high selectivity, and easy processability. For the preparation of cross-linked organic-inorganic hybrid membranes, it is preferred that the precursor organic polymer containing organic functional groups on terminals or on the side chains of the polymer backbones (or called macromolecular backbones) that can form covalent bond with an organosilicon alkoxide cross-linking agent. The organic functional groups on the precursor organic polymer can include hydroxyl (—OH), amino (—NH₂), imino (—RNH), epoxy (—CH(O)CH₂), isocyanate (—N═C═O), anhydride (—COOOC—), aldehyde (—CHO), dianhydride, amic acid, carboxylic acid (—COOH), or others as familiar to those skilled in the art. It is preferred that the precursor organic polymer exhibit a carbon dioxide or hydrogen over methane selectivity of at least about 10 for single-gas experiments, and more preferably at least about 20. The precursor organic polymer can be either a rubbery polymer or a rigid, glassy polymer. The structure of the precursor organic polymer can be linear, ladderlike, dendritic, or have a hyperbranched structure.

An appropriately selected polymer can be used which permits passage of the desired gases to be separated, for example carbon dioxide and methane. Preferably, the polymer permits one or more of the desired gases to permeate through the polymer at different diffusion rates than other components, such that one of the individual gases, for example carbon dioxide, diffuses at a faster rate through the polymer. In a preferred embodiment, the rate at which carbon dioxide passes through the polymer is at least 10 times faster than the rate at which methane passes through the polymer.

It is preferred that the membranes exhibit a carbon dioxide/methane selectivity of at least about 5, more preferably at least about 10, still more preferably at least 20, and most preferably at least about 30. Preferably, the polymer is a rigid, glassy polymer as opposed to a rubbery polymer or a flexible glassy polymer. Glassy polymers are differentiated from rubbery polymers by the rate of segmental movement of polymer chains. Polymers in the glassy state do not have the rapid molecular motion that permit the chain rotation and adjustment of segmental configurations that provide rubbery polymers their liquid-like nature and their ability to adjust segmental configurations rapidly over large distances (>0.5 nm). Glassy polymers exist in a non-equilibrium state with entangled molecular chains with immobile molecular backbones in frozen conformations. The glass transition temperature (Tg) is the dividing point between the rubbery or glassy state. Above the Tg, the polymer exists in the rubbery state; below the Tg, the polymer exists in the glassy state. Generally, glassy polymers provide a selective environment for gas diffusion and are favored for gas separation applications. Rigid, glassy polymers describe polymers with rigid polymer chain backbones that have limited intramolecular rotational mobility and are often characterized by having high glass transition temperatures (Tg>150° C.).

In rigid, glassy polymers, the diffusive selectivity tends to dominate, and glassy membranes tend to be selective in favor of small, low-boiling molecules. The preferred membranes are made from rigid, glassy polymer materials that will pass carbon dioxide preferentially over methane and other light hydrocarbons. Such polymers are well known in the art and are described, for example, in U.S. Pat. No. 4,230,463 to Monsanto and U.S. Pat. No. 3,567,632 to DuPont. Suitable membrane materials include polyimides, polysulfones and cellulosic polymers among others.

Examples of precursor organic polymers useful in the present invention include poly(ethylene glycol)s (PEG), poly(ethylene oxide)s (PEO), cellulose acetate (CA, including CA with a commercial designation of “EASTMAN” cellulose acetate (CA-398-3, 2.45 degree of substitution) from Eastman Chemical Company, Kingsport, Tenn.), cellulose triacetate (CTA, including CTA with a commercial designation of “EASTMAN” cellulose triacetate (CA-435-75S, 2.84 degree of substitution) also from Eastman Chemical Company, poly(vinyl alcohol) (PVA), poly(ethylene imine)s (PEI), poly(propylene oxide)s (PPO), co-block-poly(ethylene oxide)-poly(propylene oxide)s (PEO-PPO), tri-block-poly(propylene oxide)-poly(ethylene oxide)-poly(propylene oxide)s (PPO-PEO-PPO), poly(propylene glycol)-block-poly(ethylene glycol)-block-poly(propylene glycol) bis(2-aminepropyl ether)s (PAPE), dendritic poly(amidoamine)s, linear, ladderlike, dendritic, and hyperbranched amine-terminated polyimides, linear, ladderlike, dendritic, and hyperbranched dianhydride-terminated polyimides, polyimides with carboxylic acid groups or isocyanate groups, polyamic acids, aldehyde modified polysulfone and polyethersulfone. Preferred precursor polymers for use in the present invention include cellulose acetate, cellulose triacetate, poly(p-hydroxystyrene), polyvinyl alcohol, poly((4,4′-hexafluoroisopropylidene)-diphthalic anhydride-diaminomesitylene-3,5-diaminobenzoic acid), poly(ethylene imine), amine-terminated polyimides, amine-terminated hyperbranched polyimides, hydroxyl-terminated polyimides, and hydroxyl-terminated hyperbranched polyimides.

The organosilicon alkoxide cross-linking agents shown below that are used to form covalent bonds with the precursor organic polymer should have two characteristics. One characteristic is that these organosilicon alkoxide cross-linking agents should contain at least one organic functional group that can react with the organic functional groups on the precursor organic polymer. The other characteristic is that these organosilicon alkoxide cross-linking agents should have at least two silicon alkoxide groups that can be cross-linked with each other via a sol-gel condensation polymerization to form a fully cross-linked inter-polymer-chain network. The organosilicon alkoxide cross-linking agents have the following structure:

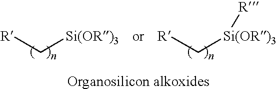

In the structures, where n=1-15; R′ is an organic functional group which is selected from the group consisting of —(CH₂)ₐNH₂ (a=1-20), —(CH₂)ₐOH (a=1-20), —(CH₂)ₐNH(CH₂)₂NH₂ (a=1-20), OCH₂CH(OH)CH₂N(CH₂CH₂OH)₂, —(CH₂)a-N═C═O (a=1-20), —(CH₂)ₐCH(O)CH₂ (a=1-20), and mixtures thereof; R″ is a C₁-C₈ hydrocarbon group; R″′ is a C₁-C₈ hydrocarbon group or an organic functional group which may include of —(CH₂)ₐNH₂ (a=1-20), —(H₂)ₐOH (a=1-20), —(CH₂)ₐNH(CH₂)₂NH₂ (a=1-20), OCH₂CH(OH)CH₂N(CH₂CH₂OH)₂, —(CH₂)a-N═C═O (a=1-20), —(CH₂)ₐCH(O)CH₂ (a=1-20), and mixtures thereof.

Among the useful organosilicon alkoxides are the following: 2-(3,4-epoxycyclohexyl)ethyltriethoxysilane, 2-(3,4-epoxycyclohexyl)ethyltrimethoxysilane, 5,6-epoxyhexyltriethoxysilane, (3-glycidoxypropyl)methyldiethoxysilane, (3-glycidoxypropyl)methyldimethoxysilane, (3-glycidoxypropyl)triethoxysilane, 3-isocyanatopropyltriethoxysilane, 3-isocyanatopropyltrimethoxysilane, triethoxysilylbutyraldehyde, 3-(triethoxysilyl)propylsuccinic anhydride, aminophenyltrimethoxysilane, 3-aminopropylmethyldiethoxysilane, 3-aminopropyltriethoxysilane, 3-aminopropyltrimethoxysilane, N-(2-aminoethyl)-3-aminopropyltrimethoxysilane, N-(2-aminoethyl)-3-aminopropylmethyldimethoxysilane, (aminoethylaminomethyl)phenethyltrimethoxysilane, bis(2-hydroxyethyl)-3-aminopropyltriethoxysilane. Other cross-linking agents that can be used include 1,3-bis(3-aminopropyl)tetramethyldisiloxane, bis(p-aminophenoxy)dimethylsilane, bis[2-(3,4-epoxycyclohexyl)ethyl]-tetramethyldisiloxane.

The preferred molar ratio of the cross-linking agent to the cross-linkable organic functional groups on the precursor polymer can within a broad range from 0.05:1 to 1:1, the more preferred molar ratio of the cross-linking agent to the cross-linkable organic functional groups on the precursor polymer can be within a range from 0.1:1 to 1:1, and the most preferred molar ratio of the cross-linking agent to the cross-linkable organic functional groups on the precursor polymer can be within a range from 0.3:1 to 1:1.

The cross-linking catalysts used to catalyze the sol-gel polymerization can be either weak bases or weak acids. More preferably, the cross-linking catalysts are weak acids such as acetic acid, lactic acid, or hydrochloric acid.

The membranes may take any form known in the art, for example hollow fibers, tubular shapes, and other membrane shapes. Some other membrane shapes include spiral wound, pleated, flat sheet, or polygonal tubes. Multiple hollow fiber membrane tubes can be preferred for their relatively large fluid contact area. The contact area may be further increased by adding additional tubes or tube contours. Contact may also be increased by altering the gaseous flow by increasing fluid turbulence or swirling.

The preferred glassy materials that provide good gas selectivity, for example carbon dioxide/methane selectivity, tend to have relatively low permeabilities. One form for the membranes is, therefore, integrally skinned or composite asymmetric hollow fibers, which can provide both a very thin selective skin layer and a high packing density, to facilitate use of large membrane areas.

Hollow fibers can be employed in bundled arrays potted at either end to form tube sheets and fitted into a pressure vessel thereby isolating the insides of the tubes from the outsides of the tubes. Devices of this type are known in the art. Preferably, the direction of flow in a hollow fiber element will be counter-current rather than co-current or even transverse.

Sheets can be used to fabricate a flat stack permeator that includes a multitude of membrane layers alternately separated by feed-retentate spacers and permeate spacers. The layers can be glued along their edges to define separate feed-retentate zones and permeate zones. Devices of this type are described in U.S. Pat. No. 5,104,532, the contents of which are hereby incorporated by reference.

The membranes can be included in a separation system that includes an outer perforated shell surrounding one or more inner tubes that contain the membranes. The shell and the inner tubes can be surrounded with packing to isolate a contaminant collection zone.

In one mode of operation, a gaseous mixture enters the separation system via a containment collection zone through the perforations in the outer perforated shell. The gaseous mixture passes upward through the inner tubes.

As the gaseous mixture passes through the inner tubes, one or more components of the mixture permeate out of the inner tubes through the selective membrane and enter the containment collection zone.

The membranes can be included in a cartridge and used for permeating contaminants from a gaseous mixture. The contaminants can permeate out through the membrane, while the desired components continue out the top of the membrane. The membranes may be stacked within a perforated tube to form the inner tubes or may be interconnected to form a self-supporting tube.

Each one of the stacked membrane elements may be designed to permeate one or more components of the gaseous mixture. For example, one membrane may be designed for removing carbon dioxide, a second for removing hydrogen sulfide, and a third for removing nitrogen. The membranes may be stacked in different arrangements to remove various components from the gaseous mixture in different orders.

Different components may be removed into a single contaminant collection zone and disposed of together, or they may be removed into different zones. The membranes may be arranged in series or parallel configurations or in combinations thereof depending on the particular application.

The membranes may be removable and replaceable by conventional retrieval technology such as wire line, coil tubing, or pumping. In addition to replacement, the membrane elements may be cleaned in place by pumping gas, liquid, detergent, or other material past the membrane to remove materials accumulated on the membrane surface.

A gas separation system including the membranes described herein may be of a variable length depending on the particular application.

The gaseous mixture can flow through the membrane(s) following an inside-out flow path where the mixture flows into the inside of the tube(s) of the membranes and the components which are removed permeate out through the tube. Alternatively, the gaseous mixture can flow through the membrane following an outside-in flow path.

In order to prevent or reduce possibly damaging contact between liquid or particulate contaminates and the membranes, the flowing gaseous mixture may be caused to rotate or swirl within an outer tube. This rotation may be achieved in any known manner, for example using one or more spiral deflectors. A vent may also be provided for removing and/or sampling components removed from the gaseous mixture.

The membranes are preferably durable, resistant to high temperatures, and resistant to exposure to liquids. The materials may be coated, ideally with a polymer, to help prevent fouling and improve durability. Examples of suitable polymers include those described in U.S. Pat. No. 5,288,304 and U.S. Pat. No. 4,728,345, the contents of which are hereby incorporated by reference. Barrier materials may also be used as a pre-filter for removing particulates and other contaminants which may damage the membranes. A corresponding process may also be used to make an asymmetric gas separation membrane.

Surprisingly, the polymeric gas separation membrane may be able to provide gas separation properties which exceed the known upper bound for various gas mixtures. Such membranes may provide gas separation properties which rival or exceed those of carbon fiber membranes or zeolite membranes.

Some of the cross-linked organic-inorganic hybrid membranes described in this present invention were fabricated as described in the following examples:

### Example 1

### Preparation of Cross-Linked Cellulose Acetate-Polyurethanepropylsilsesquioxane Organic-Inorganic Hybrid Membrane (Abbreviated Herein as CA-Urethane-Si-2-1 Membrane)

### 1) A Cross-Linkable Cellulose Acetate-Urethanepropyltriethoxysilane Organic-Inorganic Membrane Material was Synthesized According to the Procedure as Shown in FIG. 3

Five grams (18.9 mmol) of cellulose acetate polymer (“EASTMAN” Cellulose Acetate (CA-398-3) from Eastman Chemical Company, Kingsport, Tenn.) was dissolved in 119.5 grams of tetrahydrofuran or 1,4-dioxane solvent. 1.29 grams (5.2 mmol) of 3-isocyanatopropyltriethoxysilane (from Gelest, Inc, Morrisville, Pa.) was added to the CA solution. After the solution was heated at 60° C. for 48 hours, a solution containing 5.0 wt-% of the cross-linkable cellulose acetate-urethanepropyltriethoxysilane organic-inorganic membrane material was obtained. About half of the hydroxyl groups on the cellulose acetate polymer had been substituted by triethoxysilyl groups through urethane linkages in the cross-linkable cellulose acetate-urethanepropyltriethoxysilane organic-inorganic membrane material.

### 2) A Cross-Linked Cellulose Acetate-Polyurethanepropyl-Silsesquioxane Membrane was Prepared

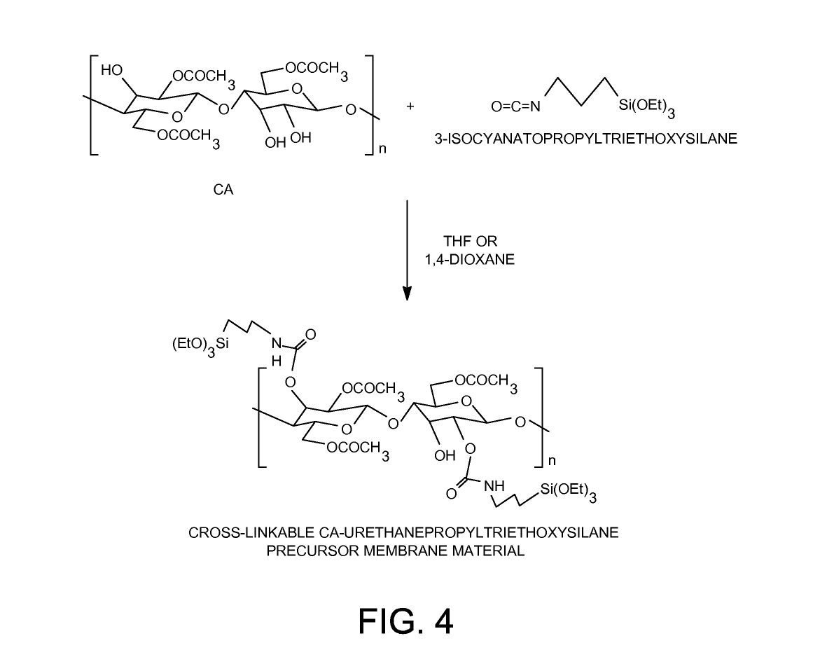

0.16 Gram of an acetic acid catalyst and 0.16 gram of ethanol were added to 16.0 grams of the solution prepared in step 1) of Example 1 containing 0.8 gram of the cross-linkable cellulose acetate-urethanepropyltriethoxysilane organic-inorganic hybrid membrane material (FIG. 3) and mixed for at least 3 hours at room temperature. The solution was then cast onto the surface of a clean glass plate, and dried at room temperature for at least 24 hours. The resulting cross-linked cellulose acetate-polyurethanepropylsilsesquioxane (FIG. 4) was detached from the glass plate and further dried at 110° C. for at least 48 hours in vacuum.

### Example 2

### Characterization of CA-Urethane-Si-2-1 Membrane

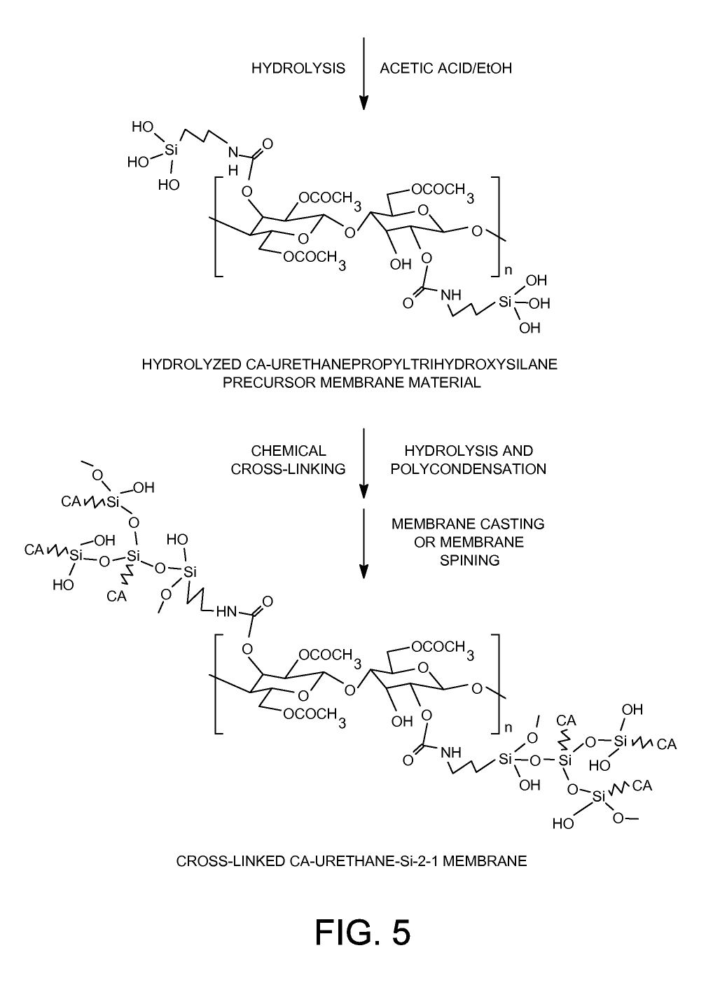

The successful formation of covalently interpolymer-chain-connected organic-inorganic hybrid networks in the cross-linked CA-Urethane-Si-2-1 membrane was confirmed by FTIR spectra. The formation of urethane linkages between cellulose acetate polymer and the inorganic polysilsesquioxane segments in the cross-linked cellulose acetate-polyurethanepropylsilsesquioxane membrane was confirmed by FTIR spectra. FIG. 5 shows the FTIR spectra of pure cellulose acetate polymer membrane and the cross-linked CA-Urethane-Si-2-1 membrane. As shown in FIG. 5, the cross-linked CA-Urethane-Si-2-1 membrane showed the appearance of a vibration band at about 1568 cm⁻¹ corresponding to a NH—CO group, indicating the formation of urethane linkages.

### Example 3

### Preparation of Cross-Linked Cellulose Acetate-Polyurethanepropylsilsesquioxane Organic-Inorganic Hybrid Membrane (Abbreviated Herein as CA-Urethane-Si-1-1 Membrane)

### 1) Synthesis of Cross-Linkable Ca-Urethanepropyltriethoxysilane Organic-Inorganic Membrane Material

5.0 Grams (18.9 mmol) of cellulose acetate polymer (“EASTMAN” Cellulose Acetate (CA-398-3) from Eastman Chemical Company, Kingsport, Tenn.) was dissolved in 144.0 grams of THF or 1,4-dioxane solvent. 2.58 grams (10.4 mmol) of 3-isocyanatopropyltriethoxysilane (from Gelest, Inc, Morrisville, Pa.) was added to the CA solution. After the solution was heated at 60° C. for 48 hours, a solution containing 5.0 wt-% of the cross-linkable CA-urethanepropyltriethoxysilane organic-inorganic membrane material was obtained. All the hydroxyl groups on the CA polymer had been substituted by triethoxysilyl groups through urethane linkages in this cross-linkable cellulose acetate-urethanepropyltriethoxysilane organic-inorganic membrane material.

### 2) Preparation of Cross-Linked Cellulose Acetate-Polyurethanepropylsilsesquioxane Membrane

0.16 Gram of an acetic acid catalyst and 0.16 gram of ethanol were added to 16.0 grams of the solution prepared in step 1) of Example 3 containing 0.8 gram of the cross-linkable cellulose acetate-urethanepropyltriethoxysilane organic-inorganic hybrid membrane material and mixed for 3 hours at room temperature. The solution was then cast onto the surface of a clean glass plate, and dried at room temperature for 24 hours. The resulting cross-linked cellulose acetate-polyurethanepropylsilsesquioxane membrane was detached from the glass plate and further dried at 110° C. for 8 hours in vacuum.

### Example 4

### Preparation of Cross-Linked Cellulose Acetate-Polyetheralkylsilsesquioxane Organic-Inorganic Hybrid Membrane (Abbreviated Herein as CA-Ether-Si-2-1 Membrane)

### 1) Synthesis of Cross-Linkable Cellulose Acetate-Etheralkyltrimethoxysilane Organic-Inorganic Membrane Material

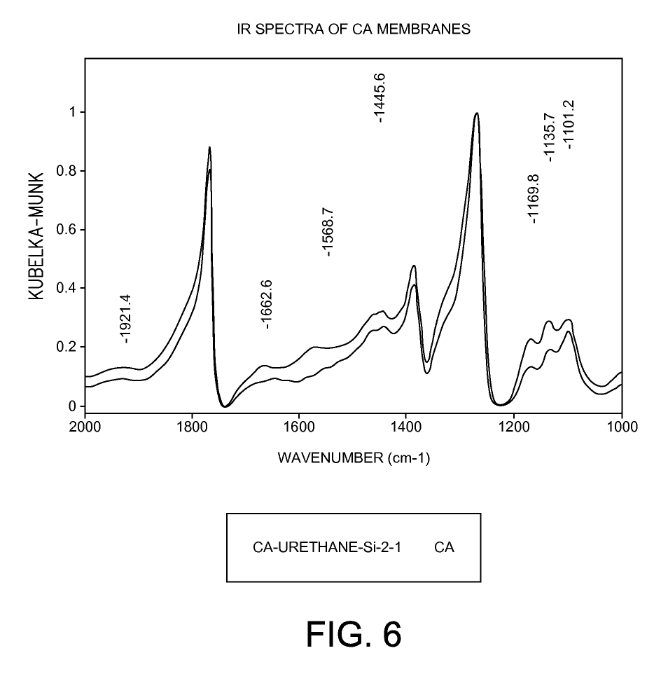

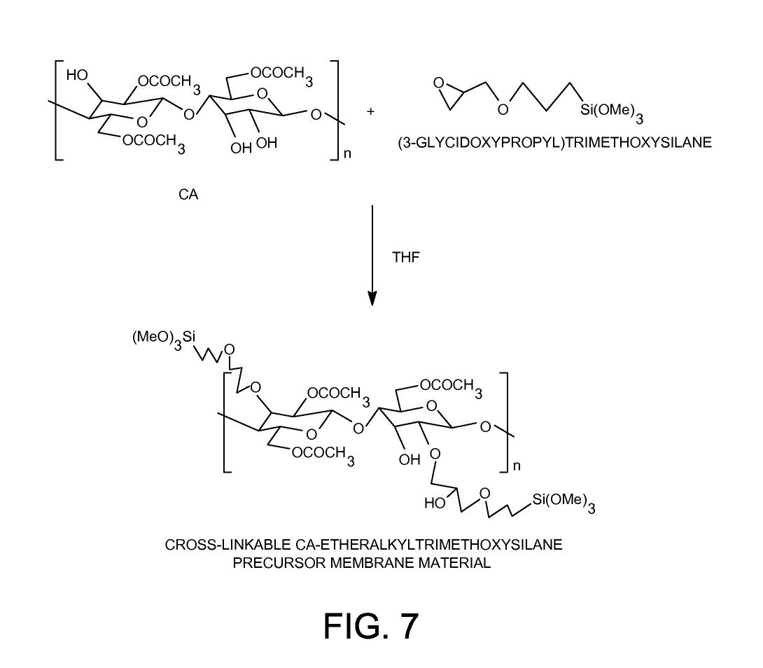

The cross-linkable cellulose acetate-etheralkyltrimethoxysilane organic-inorganic membrane material was synthesized according to the following procedure as shown in FIG. 6: 5.0 grams (18.9 mmol) of cellulose acetate polymer (“EASTMAN” Cellulose Acetate (CA-398-3) from Eastman Chemical Company) was dissolved in 118.4 grams of THF or 1,4-dioxane solvent. 1.23 grams (5.2 mmol) of (3-glycidoxypropyl) trimethoxysilane was added to the cellulose acetate solution. After the solution was heated at 60° C. for 48 hours, a solution containing 5.0 wt-% of the cross-linkable cellulose acetate-etheralkyltrimethoxysilane organic-inorganic membrane material was obtained. About half of the hydroxyl groups on cellulose acetate polymer have been substituted by trimethoxysilyl groups through ether linkages in this cross-linkable cellulose acetate-etheralkyltrimethoxysilane organic-inorganic membrane material.

### 2) Preparation of Cross-Linked Cellulose Acetate-Polyetheralkylsilsesquioxane Membrane

0.16 Gram of an acetic acid catalyst and 0.16 gram of ethanol were added to 16.0 grams of the solution prepared in step 1) of Example 4 containing 0.8 gram of the cross-linkable cellulose acetate-etheralkyltrimethoxysilane organic-inorganic hybrid membrane material and mixed for 3 hours at room temperature. The solution was then cast onto the surface of a clean glass plate, and dried at room temperature for at least 24 hours. The resulting cross-linked cellulose acetate-polyetheralkylsilsesquioxane membrane was detached from the glass plate and further dried at 110° C. for 48 hours in vacuum.

### Example 5

### Preparation of Cross-Linked Cellulose Acetate-Polyetheralkylsilsesquioxane Organic-Inorganic Hybrid Membrane (Abbreviated Herein as CA-Ether-Si-1-1 Membrane)

### 1) Synthesis of Cross-Linkable Cellulose Acetate-Etheralkyltri-Methoxysilane Organic-Inorganic Membrane Material

The cross-linkable cellulose acetate-etheralkyltrimethoxysilane organic-inorganic membrane material was synthesized according to the following procedure: 5.0 grams (18.9 mmol) of cellulose acetate polymer (“EASTMAN” cellulose acetate (CA-398-3) from Eastman Chemical Company) was dissolved in 141.7 grams of tetrahydrofuran or 1,4-dioxane solvent. 2.46 grams (10.4 mmol) of (3-glycidoxypropyl) trimethoxysilane was added to the cellulose acetate solution. After the solution was heated at 60° C. for 48 hours, a solution containing 5.0 wt-% of the cross-linkable cellulose acetate-etheralkyltrimethoxysilane organic-inorganic membrane material was obtained. All the hydroxyl groups on cellulose acetate polymer had been substituted by trimethoxysilyl groups through ether linkages in this cross-linkable cellulose acetate-etheralkyltrimethoxysilane organic-inorganic membrane material.

### 2) Preparation of Cross-Linked Cellulose Acetate-Polyetheralkylsilsesquioxane Membrane

0.16 Gram of an acetic acid catalyst and 0.16 gram of ethanol were added to 16.0 grams of the solution prepared in step 1) of Example 5 containing 0.8 gram of the cross-linkable cellulose acetate-etheralkyltrimethoxysilane organic-inorganic hybrid membrane material and mixed for at least 3 hours at room temperature. The solution was then cast onto the surface of a clean glass plate, and dried at room temperature for 24 hours. The resulting cross-linked cellulose acetate-polyetheralkylsilsesquioxane membrane was detached from the glass plate and further dried at 110° C. for 48 hours in vacuum.

### Example 6

### Preparation of Cross-Linked Cellulose Triacetate-Polyurethane-Propylsilsesquioxane Organic-Inorganic Hybrid Membrane (abbreviated herein as CTA-Urethane-Si-1-1 Membrane)

### 1) Synthesis of Cross-Linkable Cellulose Triacetateurethane-Propyl-Triethoxysilane Organic-Inorganic Membrane Material

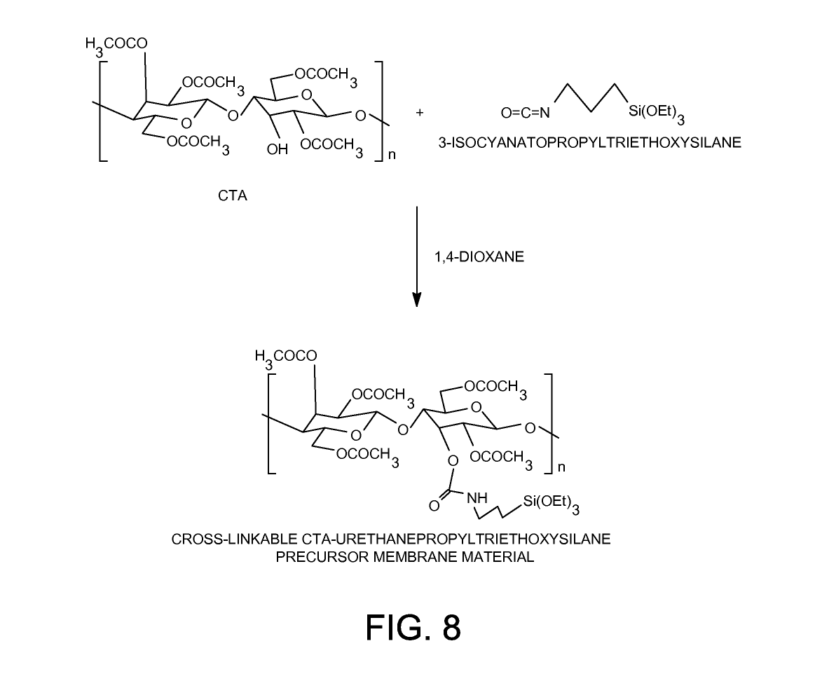

The cross-linkable cellulose triacetate-urethanepropyltriethoxysilane organic-inorganic membrane material was synthesized according to the following procedure as shown in FIG. 8: 5.0 grams (7.8 mmol) of cellulose triacetate polymer (“EASTMAN” Cellulose Triacetate (CA-435-75S) from Eastman Chemical Company) was dissolved in 183.3 grams of 1,4-dioxane solvent. 0.70 gram (2.85 mmol) of (3-isocyanatopropyl) triethoxysilane (from Gelest, Inc). After the solution was heated at 60° C. for 48 hours, a solution containing 3.0 wt-% of the cross-linkable cellulose triacetate-urethanepropyltriethoxysilane organic-inorganic membrane material was obtained. All the hydroxyl groups on cellulose triacetate polymer had been substituted by triethoxysilyl groups through urethane linkages in this cross-linkable cellulose triacetate-urethanepropyltriethoxysilane organic-inorganic membrane material.

### 2) Preparation of Cross-Linked Cellulose Triacetate-Polyurethane-Propylsilsesquioxane Membrane

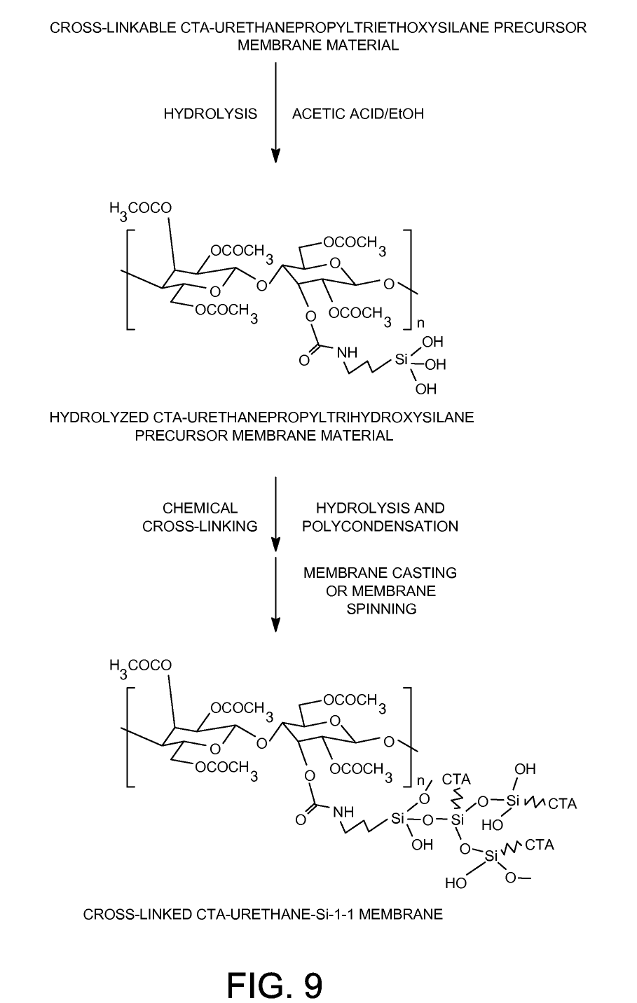

0.26 Gram of an acetic acid catalyst and 0.26 gram of ethanol were added to 26.7 grams of the solution prepared in step 1) of Example 6 containing 0.8 gram of the cross-linkable cellulose triacetate-urethanepropyltriethoxysilane organic-inorganic hybrid membrane material and mixed for 3 hours at room temperature. The solution was then cast onto the surface of a clean glass plate, and dried at room temperature for 24 hours. The resulting cross-linked cellulose triacetate-polyurethanepropylsilsesquioxane membrane (FIG. 9) was detached from the glass plate and further dried at 110° C. for 48 hours in vacuum.

### Example 7

### Preparation of Cross-Linked Cellulose Triacetate-Polyetheralkylsilsesquioxane Organic-Inorganic Hybrid Membrane (Abbreviated Herein as CTA-Ether-Si-1-1 Membrane)

### 1) Synthesis of Cross-Linkable Cellulose Triacetate-Etheralkyltrimethoxysilane Organic-Inorganic Membrane Material

The cross-linkable cellulose triacetate-etheralkyltrimethoxysilane organic-inorganic membrane material was synthesized according to the following procedure: 5.0 grams (7.8 mmol) of cellulose triacetate polymer (“EASTMAN” Cellulose Triacetate (CA-435-75S) from Eastman Chemical Company) was dissolved in 183.3 grams of 1,4-dioxane solvent. 0.674 gram (2.85 mmol) of (3-glycidoxypropyl)trimethoxysilane was added to the cellulose triacetate solution. After the solution was heated at 60° C. for 48 hours, a solution containing 3.0 wt-% of the cross-linkable cellulose triacetate-etheralkyltrimethoxysilane organic-inorganic membrane material was obtained. All the hydroxyl groups on cellulose triacetate polymer had been substituted by trimethoxysilyl groups through ether linkages in this cross-linkable cellulose triacetate-etheralkyltrimethoxysilane organic-inorganic membrane material.

### 2) Preparation of Cross-Linked Cellulose Triacetate-Polyurethanepropylsilsesquioxane

0.26 Gram of an acetic acid catalyst and 0.26 gram of ethanol were added to 26.7 grams of the solution prepared in step 1) of Example 7 containing 0.8 gram of the cross-linkable cellulose triacetate-etheralkyltrimethoxysilane organic-inorganic hybrid membrane material and mixed for 3 hours at room temperature. The solution was then cast onto the surface of a clean glass plate, and dried at room temperature for 24 hours. The resulting cross-linked cellulose triacetate-polyurethanepropylsilsesquioxane membrane was detached from the glass plate and further dried at 110° C. for 48 hours in vacuum.

### Example 8

### Preparation of Cross-Linked Cellulose Acetate-Cellulose Triacetate-Polyurethanepropylsilsesquioxane Organic-Inorganic Hybrid Membrane (abbreviated herein as CA-CTA-Urethane-Si-2-1 Membrane)

10.0 Grams of the solution containing 0.5 gram of the cross-linkable cellulose acetate-urethanepropyltriethoxysilane organic-inorganic hybrid membrane material prepared in Step 1 in Example 1 and 16.6 of the solution containing 0.5 gram of the cross-linkable cellulose triacetate-urethanepropyltriethoxysilane organic-inorganic hybrid membrane material prepared in Step 1 in Example 6 were mixed together. The mixture was stirred for 1 hour at room temperature to form a homogeneous solution. 0.20 gram of an acetic acid catalyst and 0.20 gram of ethanol were added to the homogeneous solution and mixed for 3 hours at room temperature. The solution was then cast onto the surface of a clean glass plate, and dried at room temperature for 24 hours. The resulting cross-linked cellulose acetate-cellulose triacetate-polyurethanepropylsilsesquioxane membrane was detached from the glass plate and further dried at 110° C. for 48 hours in vacuum.

### Example 9

### Preparation of Cross-Linked Cellulose Acetate-Cellulose Triacetate-Polyurethanepropylsilsesquioxane Organic-Inorganic Hybrid Membrane (abbreviated herein as CA-CTA-Urethane-Si-1-1 Membrane)

10.0 Grams of the solution containing 0.5 gram of the cross-linkable cellulose acetate-urethanepropyltriethoxysilane organic-inorganic hybrid membrane material prepared in Step 1 in Example 3 and 16.6 of the solution containing 0.5 gram of the cross-linkable cellulose triacetate-urethanepropyltriethoxysilane organic-inorganic hybrid membrane material prepared in Step 1 in Example 6 were mixed together. The mixture was stirred for 1 hour at room temperature to form a homogeneous solution. 0.20 Gram of an acetic acid catalyst and 0.20 gram of ethanol were added to the homogeneous solution and mixed for 3 hours at room temperature. The solution was then cast onto the surface of a clean glass plate, and dried at room temperature for 24 hours. The resulting cross-linked cellulose acetate-cellulose triacetate-polyurethanepropylsilsesquioxane membrane was detached from the glass plate and further dried at 110° C. for 48 hours in vacuum.

### Example 10

### Preparation of Cross-Linked Cellulose Acetate-Cellulose Triacetate-Polyetheralkylsilsesquioxane Organic-Inorganic Hybrid Membrane (abbreviated herein as CA-CTA-Ether-Si-2-1 Membrane)

10.0 Grams of the solution containing 0.5 gram of the cross-linkable cellulose acetate-etheralkyltrimethoxysilane organic-inorganic hybrid membrane material prepared in Step 1 in Example 4 and 16.6 of the solution containing 0.5 gram of the cross-linkable cellulose triacetate etheralkyltrimethoxysilane organic-inorganic hybrid membrane material prepared in Step 1 in Example 7 were mixed together. The mixture was stirred for 1 hour at room temperature to form a homogeneous solution. 0.20 gram of an acetic acid catalyst and 0.20 gram of ethanol were added to the homogeneous solution and mixed for 3 hours at room temperature. The solution was then cast onto the surface of a clean glass plate, and dried at room temperature for 24 hours. The resulting cross-linked cellulose acetate-cellulose triacetate-polyetheralkylsilsesquioxane membrane was detached from the glass plate and further dried at 110° C. for 48 hours in vacuum.

### Example 11

### Preparation of Cross-Linked Cellulose Acetate-Cellulose Triacetate-Polyetheralkylsilsesquioxane Organic-Inorganic Hybrid Membrane (abbreviated herein as CA-CTA-Ether-Si-1-1 Membrane)

10.0 Grams of the solution containing 0.5 gram of the cross-linkable cellulose acetate-etheralkyltrimethoxysilane organic-inorganic hybrid membrane material prepared in Step 1 in Example 5 and 16.6 grams of the solution containing 0.5 gram of the cross-linkable cellulose triacetate-etheralkyltrimethoxysilane organic-inorganic hybrid membrane material prepared in Step 1 in Example 7 were mixed together. The mixture was stirred for 1 hour at room temperature to form a homogeneous solution. 0.20 Gram of an acetic acid catalyst and 0.20 gram of ethanol were added to the homogeneous solution and mixed for 3 hours at room temperature. The solution was then cast onto the surface of a clean glass plate, and dried at room temperature for 24 hours. The resulting cross-linked cellulose acetate-cellulose triacetate-polyetheralkylsilsesquioxane membrane was detached from the glass plate and further dried at 110° C. for 48 hours in vacuum.

### Example 12

### Preparation of Cross-Linked Hyperbranched Poly(Imide-Silsesquioxane) Organic-Inorganic Hybrid Membrane (Abbreviated Herein as HPIS Membrane)

### 1) Synthesis of Amine-Terminated Hyperbranched Polyimide (HPI)

In a 1000 mL three-neck flask equipped with a magnetic stirrer, 5.22 grams (18 mmol) of tris(4-aminophenyl)amine (TAPA) was dissolved in 240 mL dimethylacetamide (DMAc) under nitrogen to form a purple solution at room temperature. 8 grams (18 mmol) of 2,2-bis(3,4-dicarboxyphenyl)hexafluoropropane dianhydride (6FDA) was dissolved in 120 mL dimethylacetamide (DMAc) and added dropwise into the TAPA solution over 12 hours. The reaction was allowed to continue for an additional 10 hours. 200 mL of m-xylene was added into the reaction mixture and the mixture was heated to 150° C. for 18 hours with a Dean-Stark apparatus. After cooling to room temperature, the mixture was poured into 3000 mL of methanol and yellow powder was precipitated. The crude product was collected by filtration, washed with 500 mL methanol and dried in vacuum at 60° C. overnight to yield 14.8 grams (94.1%) of yellow powder. The raw product was dissolved in 130 mL of DMAc to make a 10 wt-% solution and was filtered through a 0.2 μm polytetrafluoroethylene (PTFE) membrane filter using pressure filtration at 138 kPa (20 psi). The filtrate was poured into 1000 mL of methanol and the precipitate was collected by filtration. The precipitate was further purified using 1 L of methanol in a soxhlet extraction apparatus to remove any residual DMAc. After 15 hours of extraction, the powder was then dried in vacuum at 50° C. for 20 hours and 13.2 grams of pure product was obtained at an 85% yield.

### 2) Synthesis of Hyperbranched Poly(Imide-Silsesquioxane) Casting Solutions (HPIS)

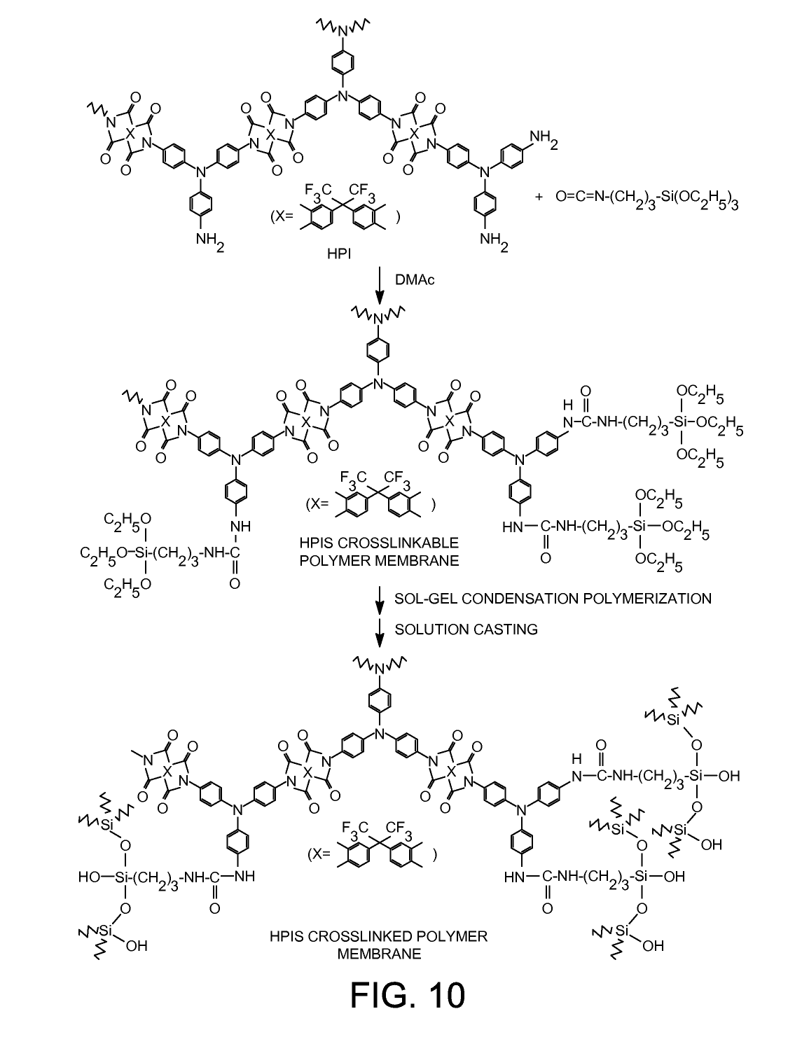

The hyperbranched poly(imide-silsesquioxane) casting solutions were prepared with amine in HPI (referring to free amine groups that were added in excess of anhydride groups during HPI synthesis) to an isocyanato group (in 3-isocyanatopropyltriethoxysilane) molar ratios of 2/1 (HPIS-1), 1/1 (HPIS-2), and 1/2 (HPIS-3). The HPI and 3-isocyanatopropyltriethoxysilane were mixed for 24 hours at room temperature in DMAc, following the reaction shown in FIG. 10. An acetic acid catalyst was added in catalyst amount and mixed for an additional 24 hours at room temperature, followed by 2 hours at 80° C. The chemical structure of the final product (HPIS) in solution is shown in FIG. 10.

### 3) Preparation of Cross-Linked HPIS Membrane

The HPIS casting solution (HPIS-1, HPIS-2 or HPIS-3) was filtered through a 0.2 μm PTFE membrane filter. The filtrate was cast onto the surface of a NaCl optical flat or a Teflon coated glass plate, and dried at 80° C. in an air oven for 24 hours. The resulting membranes (HPIS-1 membrane from HPIS-1 solution, HPIS-2 membrane from HPIS-2 solution, and HPIS-3 membrane from HPIS-3 solution) were detached from the NaCl optical flat or Teflon coated glass plate by dipping in H₂O and further dried at 150° C. for at least 48 hours in vacuo.

### Example 13

### Effect of CO₂ pressure up to 1724 kPa (250 psig) on CO₂ permeability (P_{CO2}) in cross-linked CA-Urethane-Si-2-1 and CA membranes at 50° C.

To solve the plasticization problem and to maintain the gas separation performance of CA membranes under high CO₂ pressure, organic-inorganic hybrid chemical cross-linking approach was studied as examples in this invention. By using polyorganosilsesquioxane organic-inorganic hybrid polymer as a cross-linking agent and by controlling the degree of cross-linking, the plasticization of CA polymer membranes by CO₂ was significantly reduced or even stopped. The cross-linked CA-polyorganosilsesquioxane membranes of the present invention also have improved mechanical, chemical, thermal, and pressure stabilities compared to the uncross-linked CA membrane.

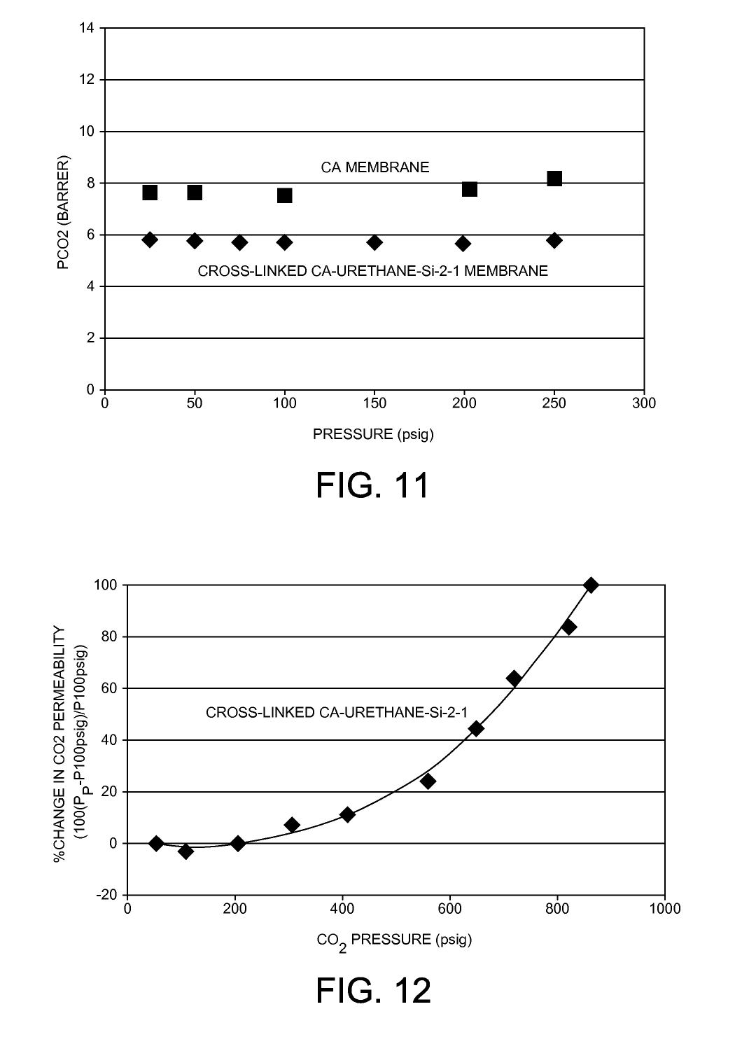

For example, as shown in FIG. 11, no pressure dependence of P_{CO2}P was observed for the cross-linked CA-Urethane-Si-2-1 membrane prepared in Example 1 with CO₂ pressure up to 1724 kPa (250 psig). However, the un-cross-linked pure CA membrane showed increased CO₂ permeability under pressure higher than 1379 kPa (200 psig) due to the plasticization (swelling) of CA polymer.

### Example 14

### Effect of CO₂ Pressure Up to 5861 kPa (850 psig) on CO₂ Permeability (P_{CO2}) in cross-linked CA-Urethane-Si-2-1 and Cross-Linked CA-CTA-Urethane-2-1 membranes at 50° C.

To solve the plasticization problem and to maintain the gas separation performance of CA membranes under high CO₂ pressure, the organic-inorganic hybrid chemical cross-linking approach was tested as shown in this invention. By using polyorganosilsesquioxane organic-inorganic hybrid polymer as a cross-linking agent and by controlling the degree of cross-linking, the plasticization of CA polymer membranes by CO₂ was significantly reduced or even stopped. The cross-linked CA-polyorganosilsesquioxane membranes also have improved mechanical, chemical, thermal, and pressure stabilities compared to the original un-cross-linked CA membrane.

For example, FIG. 12 and Table 1 show the effect of CO₂ pressure up to 5861 kPa (850 psig) on CO₂ permeability (P_{CO2}) in the cross-linked CA-Urethane-Si-2-1 and cross-linked CA-CTA-Urethane-2-1 membranes prepared in Example 1 and Example 8, respectively, at 50° C. P_{CO2} increased only about 24% for the cross-linked CA-Urethane-Si-2-1 membrane when the CO₂ pressure increased from 689 to 3447 kPa (100 to 500 psig). Similarly, P_{CO2} increased only about 16% for the cross-linked CA-CTA-Urethane-Si-2-1 membrane when the CO₂ pressure increased from 689 to 3447 kPa (100 to 500 psig). In comparison, Puleo, Paul, et al. had already reported in J. MEMBR. SCI., 47: 301 (1989) that the un-cross-linked pure CA membrane and CTA membrane showed a dramatic increase in P_{CO2} when the CO₂ pressure increased from 689 to 3447 kPa (100 to 500 psig) due to the plasticization (swelling) of CA and CTA polymers. Puleo, Paul, et al. reported that P_{CO2}P of CA membrane increased about 50-60% and P_{CO2} of CTA membrane increased about 150% when the CO₂ pressure increased from 689 to 3447 kPa (100 to 500 psig). These comparisons of results on CA and CTA membranes in the literature and the results of the experiments that we conducted on the cross-linked CA-Urethane-Si-2-1 and cross-linked CA-CTA-Urethane-2-1 membranes of the present invention demonstrated that the chemical cross-linking approach described in this invention is truly an effective approach to significantly suppress or even almost stop plasticization of polymeric membranes.

TABLE 1
Effect of CO₂ pressure on CO₂ permeability (P_{CO2}) in cross-linked CA-Urethane-Si-
2-1 and cross-linked CA-CTA-Urethane-Si-2-1 membranes at 50° C. *

| | | Ratio of P(p)/P(100) | | Ratio of P(p)/P(100) |
|---|---|---|---|---|
| | Ratio of P(p)/P(100) | for cross-linked CA- | Ratio of P(p)/P(100) | for cross-linked CA- |
| CO₂ pressure | for CA | Urethane-Si-2-1 | for CTA(1:1) | CTA-Urethane-Si-2-1 |
| (P(p), psig) | (P(100)) ^{a} | (P(100)) | (P(100)) ^{a} | (P(100)) |
| 100 | 1.00 | 1.00 | 1.00 | 1.00 |
| | (~4-5 barrers) | (~4-5 barrers) | (~6-7 barrers) | (~12-13 barrers) |
| 300 | | 1.07 | | 1.03 |
| 500 | ~1.50-1.60 | 1.24 | ~2.52 | 1.16 |
| 800 | | 1.85 | | 1.61 |

* 1 barrer = 10⁻¹⁰ cm³(STP) · cm/cm^{2 ·} sec · cmHg
^{a} Data reported by Puleo, Paul, et al. in J. MEMBR. SCI., 47: 301 (1989) and the membranes were tested at 35° C.

### Example 15

### Preparation of Cellulose Acetate (CA) Membrane (for Comparison Purposes)

1.0 Gram of cellulose acetate polymer (“EASTMAN” Cellulose Acetate (CA-398-3) from Eastman Chemical Company) was dissolved in 20.0 grams of THF or 1,4-dioxane solvent. The mixture was stirred at room temperature for about 12 hours to form a homogeneous solution. The solution was cast onto the surface of a clean glass plate, and dried at room temperature for 24 hours. The resulting cellulose acetate membrane was detached from the glass plate and further dried at 110° C. for at least 48 hours in vacuo.

### Example 16

### Preparation of Cellulose Acetate-Cellulose Triacetate Membrane (for Comparison Purpose)

0.5 Gram of cellulose acetate polymer (“EASTMAN” Cellulose Acetate (CA-398-3) from Eastman Chemical Company) and 0.5 gram of cellulose triacetate polymer (“EASTMAN” Cellulose Triacetate (CA-435-755) from Eastman Chemical Company) were dissolved in 20.0 grams of 1,4-dioxane solvent. The mixture was stirred at room temperature for about 12 hours to form a homogeneous solution. The solution was cast onto the surface of a clean glass plate, and dried at room temperature for 24 hours. The resulting cellulose acetate-cellulose triacetate membrane was detached from the glass plate and further dried at 110° C. for at least 48 hours in vacuo.

The permeabilities of CO₂ and CH₄ (P_{CO2} and P_{CH4}) and ideal selectivity for CO₂/CH₄ (α_{CO2/CH4}) of the cellulose acetate, cellulose acetate-cellulose triacetate, and the cross-linked cellulose acetate and cross-linked cellulose acetate-cellulose triacetate membranes were measured by pure gas measurements at 50° C. under 689 kPa (100 psig) single gas pressure.

TABLE 2
Pure gas permeation results for cellulose acetate and cross-
linked cellulose acetate membranes for CO₂/CH₄ separation*

| | P_{CO2} | Δ P_{CO2} | P_{CH4} | |
|---|---|---|---|---|
| Film | (barrer) | (barrer) | (barrer) | α_{CO2/CH4} |
| Cellulose Acetate (CA) | 8.61 | — | 0.383 | 22.5 |
| Cross-linked CA-Urethane- | 4.53 | −47% | 0.212 | 21.4 |
| Si-2-1 | | | | |
| Cross-linked CA-Urethane- | 3.81 | −56% | 0.180 | 21.2 |
| Si-1-1 | | | | |

*Tested at 50° C. and 689 kPa (100 psig); 1 barrer = 10⁻¹⁰ cm³ (STP) · cm/cm² · sec · cmHg

It has been demonstrated from pure gas permeation results as shown in Table 2 that the cross-linked CA-Urethane-Si-2-1 and the cross-linked CA-Urethane-Si-1-1 membranes exhibited no loss in CO₂/CH₄ selectivity compared to the cellulose acetate membrane without cross-linking, but the CO₂ permeability decreased about 50% at 50° C. and under 689 kPa (100 psig).

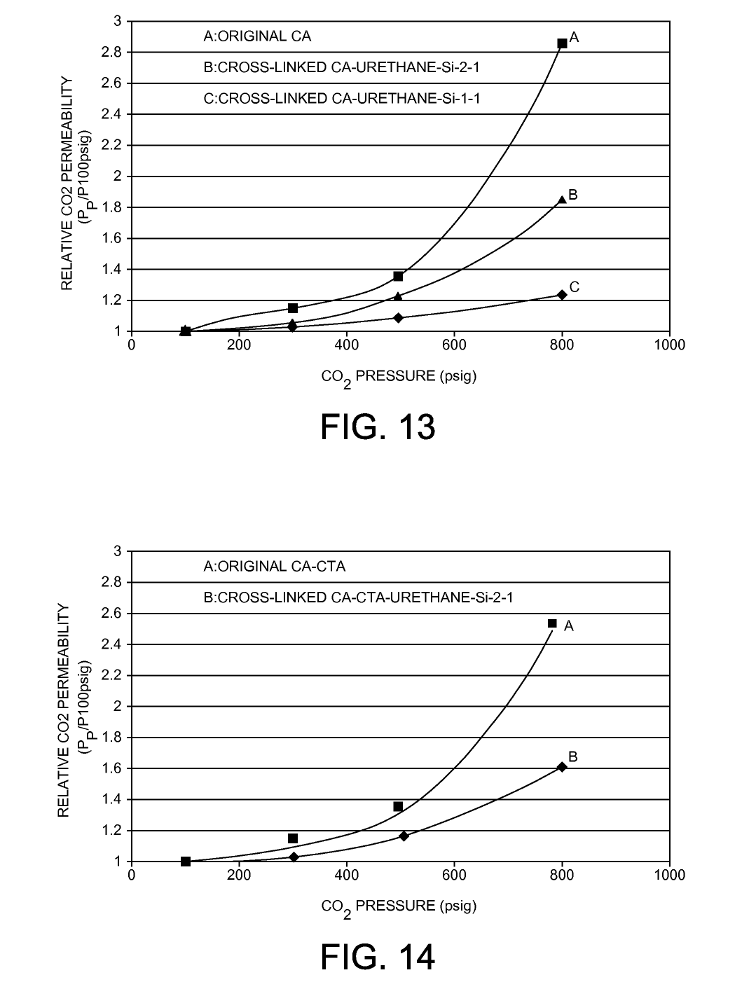

One of the objectives of this work was to determine the effect of chemical cross-linking on the plasticization resistance of a cellulose acetate membrane. The membranes were conditioned with CO₂ at different pressures to study the relationship between CO₂ permeability and the applied pressure. FIG. 13 shows the change of the relative permeability of CO₂ with the increase of the applied CO₂ pressure at 50° C. It can be seen that the original cellulose acetate membrane exhibited a 36% increase in CO₂ permeability under the applied CO₂ pressure of 3447 kPa (500 psig) compared to that under 689 kPa (100 psig) applied CO₂ pressure. When the applied CO₂ pressure increased to 5516 kPa (800 psig), the original cellulose acetate membrane exhibited 186% increase in CO₂ permeability. This significant CO₂ permeability increase when the applied CO₂ pressure is approximately above 2068 kPa (300 psig) is due to the CO₂ plasticization (swelling) of the cellulose acetate polymer. As shown in FIG. 13, it has been demonstrated that the CO₂ plasticization resistance of the cross-linked CA-Urethane-Si-2-1 and the cross-linked CA-Urethane-Si-1-1 membranes with different degree of cross-linking was significantly enhanced compared to the original cellulose acetate membrane. The CO₂ permeability increased about 24% for the cross-linked CA-Urethane-Si-2-1 membrane when the CO₂ pressure increased from 689 to 3447 kPa (100 to 500 psig) and increased about 85% when the CO₂ pressure increased 5516 kPa (800 psig). Similarly, as shown in FIG. 13, the CO₂ permeability increased only about 12% for the cross-linked CA-Urethane-Si-1-1 membrane with higher cross-linking degree than the cross-linked CA-Urethane-Si-2-1 membrane when the CO₂ pressure increased from 689 to 3447 kPa (100 to 500 psig) and increased only about 23% when the CO₂ pressure increased 5516 kPa (800 psig). The significant enhancement in CO₂ plasticization resistance for the cross-linked CA-Urethane-Si-2-1 and the cross-linked CA-Urethane-Si-1-1 membranes compared to the original cellulose acetate membrane is mainly attributed to the chemical cross-linking and formation of a rigid covalently interpolymer-chain-connected hybrid networks. The further significant enhancement in CO₂ plasticization resistance for the cross-linked CA-Urethane-Si-1-1 membrane compared to the cross-linked CA-Urethane-Si-2-1 membrane should be due to the much higher degree of cross-linking of cellulose acetate membrane. These comparison results on cellulose acetate and cross-linked CA membranes in FIG. 13 demonstrated that the chemical cross-linking approach described in this invention is an effective method to significantly suppress or even almost stop plasticization of polymeric membranes induced by condensable gases such as CO₂ or propylene.

The CO₂/CH₄ separation performance of a cellulose acetate-cellulose triacetate blend polymeric membrane and its cross-linked membranes were also studied. It has been demonstrated from pure gas permeation results as shown in Table 3 that the cross-linked CA-CTA-Urethane-Si-2-1 organic-inorganic hybrid membrane exhibited more than 50% increase in CO₂ permeability with only slight decrease in CO₂/CH₄ selectivity compared to the original cellulose acetate-cellulose triacetate membrane at 50° C. and under 689 kPa (100 psig). The cross-linked CA-CTA-Urethane-Si-1-1 organic-inorganic hybrid membrane with higher degree of cross-linking than the cross-linked CA-CTA-Urethane-Si-2-1 membrane exhibited more than 150% increase in CO₂ permeability with slight decrease in CO₂/CH₄ selectivity compared to the original cellulose acetate-cellulose triacetate membrane at 50° C. and under 689 kPa (100 psig). More importantly, the cross-linking of cellulose acetate and cellulose triacetate polymer by inorganic silsesquioxane segments can effectively reduce the plasticization of cellulose acetate-cellulose triacetate polymeric membrane by CO₂. FIG. 14 shows the change of CO₂ relative permeability with the increase of the applied CO₂ pressure at 50° C. It can be seen that the original cellulose acetate-cellulose triacetate membrane exhibited 44% increase in CO₂ permeability under the applied CO₂ pressure of 3447 kPa (500 psig) compared to that under 689 kPa (100 psig) applied CO₂ pressure. When the applied CO₂ pressure increased to 5516 kPa (800 psig), the original cellulose acetate-cellulose triacetate membrane exhibited 149% increase in CO₂ permeability. This significant CO₂ permeability increase when the applied CO₂ pressure is approximately above 2068 kPa (300 psig) is due to the CO₂ plasticization (swelling) of cellulose acetate and cellulose triacetate polymers. As shown in FIG. 14, it has been demonstrated that the CO₂ plasticization resistance of the cross-linked CA-CTA-Urethane-Si-2-1 membrane was significantly enhanced compared to the original cellulose acetate membrane. The CO₂ permeability only increased about 16% for the cross-linked CA-CTA-Urethane-Si-2-1 membrane when the CO₂ pressure increased from 689 to 3447 kPa (100 to 500 psig) and increased about 60% when the CO₂ pressure increased 5516 kPa (800 psig). The significant enhancement in CO₂ plasticization resistance for the cross-linked CA-CTA-Urethane-Si-2-1 membrane compared to the original cellulose acetate-cellulose triacetate membrane is mainly attributed to the chemical cross-linking and formation of a rigid covalently interpolymer-chain-connected hybrid networks. These comparison results on the original cellulose acetate-cellulose triacetate and cross-linked cellulose acetate-cellulose triacetate membranes in FIG. 14 demonstrated that our chemical cross-linking approach described in this invention is also an effective method to significantly suppress or even almost stop plasticization of blend polymeric membranes such as cellulose acetate-cellulose triacetate blend membrane induced by condensable gases such as CO₂ or propylene.

TABLE 3
Pure gas permeation results for cellulose acetate - cellulose
triacetate and cross-linked cellulose acetate - cellulose triacetate
membranes for CO₂/CH₄ separation*

| | P_{CO2} | Δ P_{CO2} | P_{CH4} | |
|---|---|---|---|---|
| Film | (barrer) | (barrer) | (barrer) | α_{CO2/CH4} |
| CA-CTA | 8.74 | — | 0.405 | 21.6 |
| Cross-linked CA-CTA- | 13.7 | 57% | 0.723 | 18.9 |
| Urethane-Si-2-1 | | | | |
| Cross-linked CA-CTA- | 22.6 | 159% | 1.29 | 17.5 |
| Urethane-Si-1-1 | | | | |

*Tested at 50° C. and 689 kPa (100 psig); 1 barrer = 10⁻¹⁰ cm³(STP) · cm/cm² · sec · cmHg

In summary, the high plasticization-resistant cross-linked organic-inorganic hybrid membranes described in this invention such as cellulose acetate-polyurethanepropylsilsesquioxane, cellulose triacetate-polyurethanepropylsilsesquioxane and cellulose acetate-cellulose triacetate-polyurethanepropylsilsesquioxane organic-inorganic hybrid membranes contain covalently interpolymer-chain-connected hybrid networks. CO₂ plasticization tests demonstrated that the covalently cross-linked network structures in the cross-linked organic-inorganic hybrid membranes described in this invention effectively reduced or stopped the swelling of the polymer to such an extent that intermolecular interactions cannot be disrupted under CO₂ pressure up to 5516 kPa (800 psig). As a result, significantly enhanced stability of the polymer membrane against plasticization was successfully achieved by the chemical cross-linking approach described in this invention.

The high plasticization-resistant cross-linked organic-inorganic hybrid membranes described in this invention such as cellulose acetate-polyurethanepropylsilsesquioxane, cellulose triacetate-polyurethanepropylsilsesquioxane and cellulose acetate-cellulose triacetate-polyurethanepropylsilsesquioxane organic-inorganic hybrid membranes can be used in any convenient form such as sheets, tubes or hollow fibers for a variety of liquid and gas separations such as separations of CO₂/CH₄, H₂/CH₄, O₂/N₂, CO₂/N₂, olefin/paraffin, iso/normal paraffins, polar molecules such as H₂O, H₂S, and NH₃/mixtures with CH₄, N₂, H₂, and other light gases separations, as well as desalination and pervaporation applications. The high plasticization-resistant cross-linked organic-inorganic hybrid polymer membranes of the present invention are especially useful in gas separation processes in petrochemical, refinery, and natural gas industries. Examples of such separations include separation of CO₂ from natural gas or flue gas, H₂ from N₂, CH₄, and argon in ammonia purge gas streams, H₂ recovery in refineries, olefin/paraffin separations such as propylene/propane separation, and iso/normal paraffin separations. In addition to being used for membranes that are used to separate gases or liquids, these cross-linked polymers can be used in a variety of other applications such as, but not limited to thin films for fuel cell applications, filters for filtrations and water purifications, binders for catalyst or adsorbent preparation, and substrates for drug delivery.

1. A process for separating at least one gas from a mixture of gases, the process comprising:
a) providing a chemically cross-linked polymer membrane comprising an organic polymer, an organosilsesquioxane segment, and a covalent bond between said organic polymer and said organosilsesquioxane segment wherein said cross-linked organic-inorganic hybrid membrane is permeable to said at least one gas;
b) contacting the mixture of gases to a first side of the membrane to cause said at least one gas to permeate the cross-linked organic-inorganic hybrid membrane; and
c) removing from a second side of the cross-linked organic-inorganic hybrid membrane a permeate gas composition comprising at least a portion of said at least one gas which permeated said cross-linked organic-inorganic hybrid membrane.

2. The process of claim 1 wherein said organic polymer is selected from the group consisting of poly(ethylene glycol)s; poly(ethylene oxide)s; cellulose acetate; cellulose triacetate; poly(ethylene imine)s; polyimide comprising a repeating unit obtained from aromatic diamine including at least one ortho-positioned hydroxyl functional group and mixtures thereof.

3. The process of claim 1 wherein said mixture of gases comprises a pair of gases selected from the group consisting of carbon dioxide/natural gas, hydrogen/methane, carbon dioxide/nitrogen, methane/nitrogen, iso/normal paraffins and olefins/paraffins.

4. The process of claim 1 wherein said organosilsesquioxane segment is selected from the group consisting of ethylsilsesquioxane, propylsilsesquioxane, hexylsilsesquioxane, and mixtures thereof.

5. The process of claim 1 wherein said covalent bond is selected from the group consisting of an ether bond, a urethane bond, and mixtures thereof.

6. A chemically cross-linked polymer membrane comprising an organic polymer, an organosilsesquioxane segment, and a covalent bond between said organic polymer and said organosilsesquioxane segment wherein said chemically cross-linked polymer membrane is permeable to at least one gas.

7. The membrane of claim 6 wherein said organic polymer is selected from the group consisting of poly(ethylene glycol); poly(ethylene oxide); cellulose acetate; cellulose triacetate; polyimide comprising a repeating unit obtained from aromatic diamine including at least one ortho-positioned hydroxyl functional group and mixtures thereof.

8. The membrane of claim 6 wherein said organosilsesquioxane segment is selected from the group consisting of ethylsilsesquioxane, propylsilsesquioxane, hexylsilsesquioxane and mixtures thereof.

9. The membrane of claim 6 wherein said covalent bond is selected from the group consisting of an ether bond, a urethane bond and mixtures thereof.

10. The membrane of claim 6 wherein said chemically cross-linked polymer membrane has a geometry selected from the group consisting of sheets, hollow fibers and tubes.
